(19) United States
(12) Patent Application Publication
(10) Pub. No.: US 2008/0193158 A1
(43) Pub. Date: Aug. 14, 2008

(54) Image Forming Apparatus

(75) Inventors: Masakatsu Kiwada, Tokyo (JP); Naoya Misawa, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/765,619

(22) Filed: Jun. 20, 2007

(30) Foreign Application Priority Data
Feb. 13, 2007 (JP) 2007-031938

(51) Int. Cl. G03G 15/00; G06F 17/00

(52) U.S. Cl. 399/82; 235/375

(57) ABSTRACT

Disclosed is an image forming apparatus to perform an image forming processing based on a print job including: a sheet feeding section to feed a stored printing sheet; a punching section to perform a punching processing in a printing sheet; and a control section to allow the punching section to perform the punching processing to form a punched hole corresponding to a punched hole in a pre-punched printing sheet specified by the print job when an image processing based on the print job is executed.

### CROSS-REFERENCE TO RELATED APPLICATIONS

The present U.S. patent application claims priority under the Paris Convention of Japanese Patent Application No. 2007-031938 filed on Feb. 13, 2007 to the Japanese Patent Office, which shall be a basis for correcting mistranslations.

### BACKGROUND

1. Field of the Invention

The present invention relates to an image forming apparatus in which an image forming processing is executed based on a print job specifying a pre-punched printing sheet.

2. Description of Related Art

Lately, in image forming apparatuses such as printers, various types of printing sheets such as printing sheets with a pre-punched hole, printing sheets with a tab, are used. Particularly, the JDF (Job Definition Format) standard, predicted to become the mainstream in the future, specifies, in an attribute of a printing sheet, “pre-punched hole presence” indicating whether a punched hole is present and “punched hole attribute” such as number, spacing, etc. of the punched holes.

Along with the use of such various types of printing sheets, techniques for image forming apparatuses compliant with such types of sheets have been developed.

One example is a technique where by detecting a location of a tab of a fed printing sheet, when the printing sheet does not have a tab for an image to be formed, the sheet is discharged without forming the image and when a printing sheet with a tab where an image is to be formed is fed, an image forming is executed (Japanese Patent Application Laid-Open Publication No. 2001-13823, hereinafter referred to as patent literature 1).

Also, another example is a technique where even if a printing sheet to be fed has a pre-punched hole, the sheet is detected without false detection and the sheet is stably supplied without damaging the sheet (Japanese Patent Application Laid-Open Publication No. 11-59960, hereinafter referred to as patent literature 2).

However, the technique of the patent literature 1 controls whether or not to execute the printing depending on the attribute of the printing sheet (in the patent literature 1, the presence of the tab and the characteristics of the tab), thus if the printing sheet to be fed is not the printing sheet of the attribute specified by the user, the user must set another printing sheet of the specified attribute, laying a heavy burden on the user.

As for the technique of the patent literature 2, if the user desires to form an image on a printing sheet with a pre-punched hole, when a printing sheet without a pre-punched hole is fed, the user must set a printing sheet with a pre-punched hole into the sheet feeding section. Alternatively, after an image is formed on a printing sheet without a punched hole, the user must do the punching process on the printing sheet himself. Thus, as in the case of the patent literature 1, a heavy burden has been laid on the user.

Further, even in an image forming apparatus comprising a punching section, if the user desires to form an image on a printing sheet with a pre-punched hole, there are cases where the printing sheet with the pre-punched hole is not stored in the image forming apparatus. In such a case, the user must set the punching section to execute a punching process or must set the printing sheet with the pre-punched hole, laying a heavy burden on the user.

### SUMMARY

The present invention has been made in consideration of the above problems, and it is one of objects of the present invention to reduce a burden of user operation when a printing sheet with a punched hole is not stored in the image forming apparatus.

To achieve at least one of the above objects, an image forming apparatus reflecting one aspect of the present invention comprises:

a sheet feeding section to feed a stored printing sheet;

a punching section to perform a punching processing in a printing sheet; and

a control section to allow the punching section to perform the punching processing to form a punched hole corresponding to a punched hole in a pre-punched printing sheet specified by the print job when an image processing based on the print job is executed.

It is preferable that the control section determines whether the pre-punched printing sheet specified by the print job is stored in the sheet feeding section, and when the pre-punched printing sheet is determined to be stored, the control section allows the sheet feeding section to feed the pre-punched printing sheet, and when the pre-punched printing sheet is determined to be not stored, the control section allows the punching section to perform the punching processing to form the punched hole corresponding to the punched hole in the printing sheet specified by the print job.

It is preferable that the control section refers to presence or absence of the pre-punched hole and an attribute of the pre-punched hole in the printing sheet stored in the sheet feeding section, and determines whether the pre-punched printing sheet specified by the print job is stored in the sheet feeding section.

It is preferable that the control section refers to an attribute of a punched hole which the punching section can form and presence or absence of the punched hole in the printing sheet stored in the sheet feeding section to allow the punching section to perform the punching processing to form the punched hole corresponding to the punched hole in the printing sheet specified by the print job.

It is preferable that the image forming apparatus further comprises an operating section to receive a setting input of presence or absence of the pre-punched hole and an attribute of the pre-punched hole in the printing sheet stored in the sheet feeding section, wherein the control section refers to information set based on the setting input received by the operating section.

It is preferable that the sheet feeding section comprises an optical sensor to detect presence or absence of the pre-punched hole and an attribute of the pre-punched hole in the printing sheet stored in the sheet feeding section, and the control section refers to information detected by the optical sensor.

It is preferable that the control section performs the determination with respect to each page of the printing sheet.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a diagram showing an apparatus configuration of an image forming apparatus;

FIG. 2 is a block diagram showing the image forming apparatus;

FIG. 3 is a flow chart showing image forming processing;

FIG. 4 is a diagram showing a data configuration of printing job information;

FIG. 5 is a diagram showing a data configuration of punching function information;

FIG. 6 is a diagram showing a data configuration of punched hole attribute information;

FIG. 7 is a diagram showing a data configuration of sheet feeding section information; and

FIG. 8 is an example of a printing sheet supply screen.

### DETAILED DESCRIPTION OF PREFERRED EMBODIMENTS

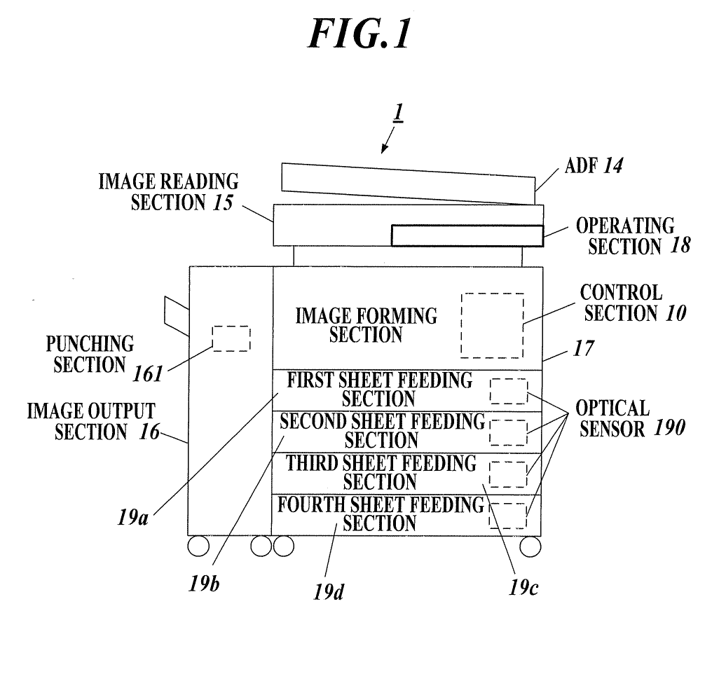

Embodiments of the present invention will be described with detail below, with reference to FIG. 1-FIG. 8.

### (Function Configuration of Image Forming Apparatus)

FIG. 1 shows a configuration of an image forming apparatus. An image forming apparatus 1 is an apparatus which forms an image on a recording medium such as a printing sheet, etc., and comprises a control section 10, an ADF (Auto Document Feeder) 14, an image reading section 15, an image output section 16, an image forming section 17, an operating section 18, a first sheet feeding section 19a, a second sheet feeding section 19b, a third sheet feeding section 19c, and a fourth sheet feeding section 19d.

The ADF 14 is an automatic document feeder, which automatically feeds one or a plurality of sheets of original documents to the image reading section 15.

The image reading section 15 is a functional section where image data is generated by optically reading an image in an original document on a document stage. Specifically, the image reading section 15 optically scans through a contact glass an original document fed by the ADF 14 or optically scans an original document placed on a platen glass making a photoelectric conversion with a CCD (Charge-Coupled Device) image sensor to read the image recorded on the original document. Then, the image reading section 15 generates image data of the image to output it to the image forming section 17.

The image forming section 17 is a functional section for forming an image which comprises a photoreceptor, a transfer belt, a fuser, various carrier belts, etc. (all not shown). The image forming section 17 forms an image on a printing sheet based upon image data read by the image reading section 15 or a print job received through the communication I/F section, and sends the printing sheet to the image output section 16. As a way of forming the image, well-known imaging processing such as electrophotography, electrostatic recording, etc. is used.

The control section 10 controls each functional section, and comprises a CPU (Central Processing Unit), a RAM (Random Access Memory), a memory section, etc. A specific explanation will be done below.

The first sheet feeding section 19a, the second sheet feeding section 19b, the third sheet feeding section 19c, and the fourth sheet feeding section 19d store a printing sheet. They also send the stored printing sheet to the image forming section 17. Each sheet feeding section includes an optical sensor 190 and detects “pre-punched hole presence”, “punched hole attribute”, etc., of the printing sheet. Hereinafter the first sheet feeding section 19a to the fourth sheet feeding section 19d are collectively referred to as a sheet feeding section 19.

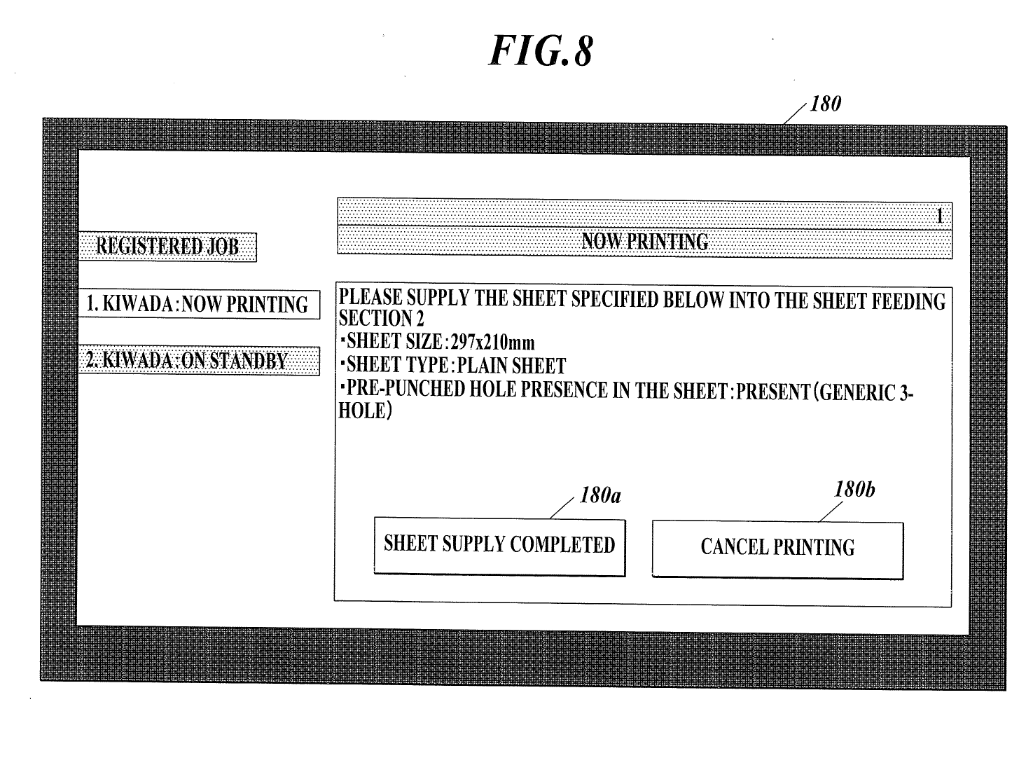

The operating section 18 comprises operation input keys, a touch panel, etc. and outputs a signal corresponding to a key pushed down and a signal corresponding to a location touched on the touch panel to the control section 10. The operating section 18 displays a warning to the user concerning punching as shown in an example screen of “printing sheet supply screen” of FIG. 8. Together with the warning, the operating section 18 displays choices to select to supply the printing sheet to execute the printing or to cancel the printing.

The user uses the touch panel included in the operating section 18 to execute operations described below such as an operation of setting printing job information, an operation of starting printing, etc.

The image output section 16 is a functional section to perform a finishing processing such as punching, stapling, binding, etc., to the sheets conveyed by the image forming section 17 according to an instruction from the control section 10, and then to output them. The image output section 16 includes a punching section 161 for punching a hole in the printing sheet. An attribute of a punched hole which can be punched by the punching section 161 depends on the characteristics of the punching section 161.

### (Function Configuration and Data Configuration of Control Section)

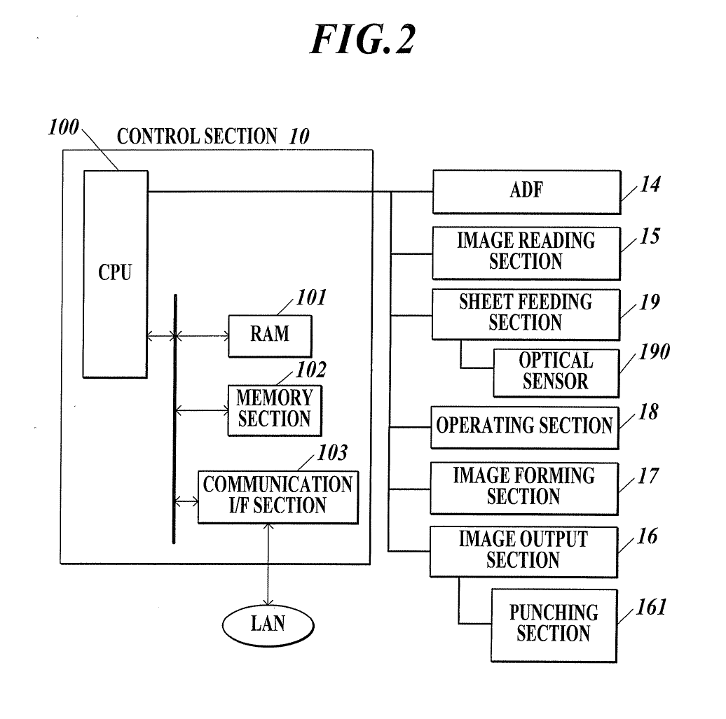

FIG. 2 is a block diagram of the control section 10 and functional sections. The control section 10 comprises a CPU 100, a RAM 101, a memory section 102 and a communication I/F section 103, and these are communicably connected with one another through a bus. The CPU 100 is communicably connected to the ADF 14, the image reading section 15, the sheet feeding section 19, the operating section 18, the image forming section 17 and the image output section 16 through a bus. An optical sensor 190 is communicably connected to the sheet feeding section 19, and the punching section 161 is communicably connected to the image output section 16. The communication I/F section 103 is communicably connected to a network such as a LAN.

The CPU 100 centrally manages and controls the image forming apparatus 1 by controlling operations of functional sections, controlling input and output of data between the functional sections, etc. Specifically, the functional sections are, the ADF 14, the image reading section 15, the sheet feeding section 19, the operating section 18, the image forming section 17, and the image output section 16. When the CPU 100 receives a print job, the CPU 100 analyzes the print job to output instructions for the image forming processing to the respective functional sections.

The RAM 101 is a section to temporarily store various kinds of data read by the image reading section 15 or input through the communication I/F section 103. The stored image data is processed by the CPU 100, and when necessary, transferred to the memory section 102 or the image forming section 17.

Also, the RAM 101 stores a “print job”. The print job includes, for example, printing job information on printing conditions and image data of a printing object image. The image data, for example, consists of data of the four colors of C (cyan), Y (yellow), M (magenta), and K (black). The CPU 100 receives the print job from other communication apparatuses through the communication I/F section 103. The image data may be information read by the image reading section 15 and the printing job information may be information set by an input signal from the operating section 18. When the communication I/F section 103 receives the print job, the CPU 100 allows the RAM 101 to store the print job. The print job may have an image of a printing object in a file format such as the PDF (Portable Document Format) format, the XPS (XML Paper Specification) format, etc. instead of image data.

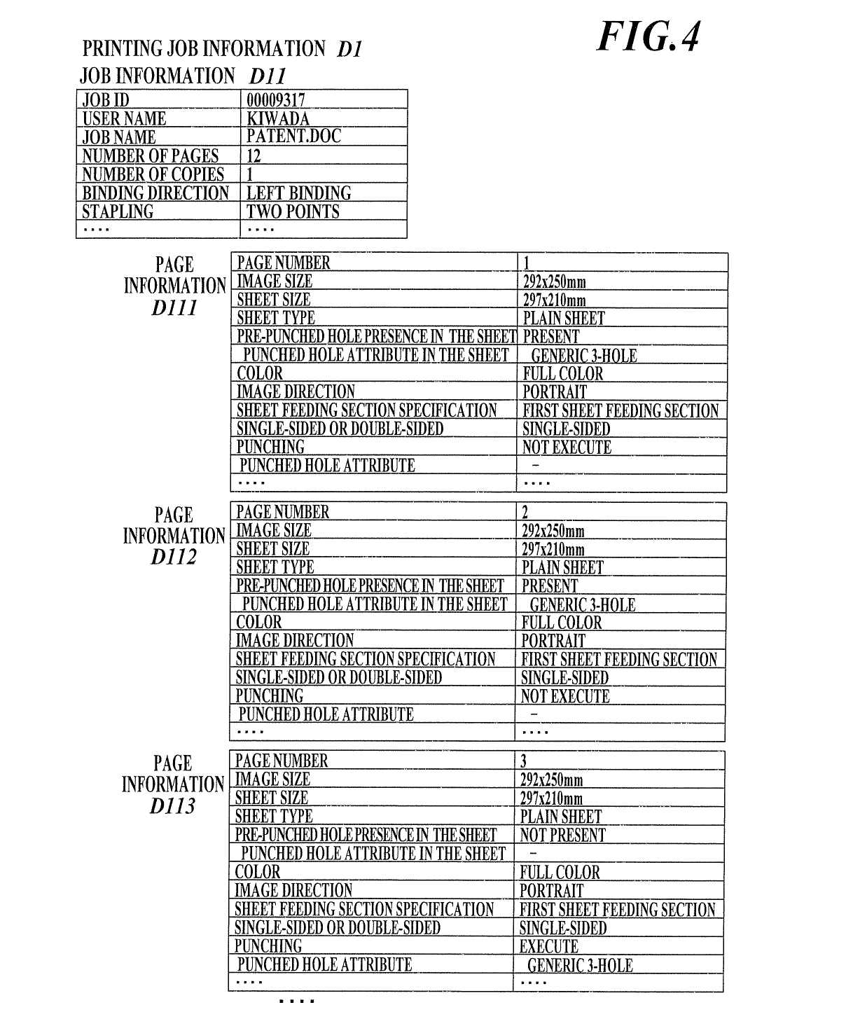

The data configuration of the printing job information is shown in FIG. 4. The printing job information D1 includes one piece of “job information” and one or a plurality pieces of “page information”. The job information D11 has information of “job ID”, “user name”, “job name”, “number of pages”, “number of copies”, “binding direction”, “stapling”, etc. The page information D111 (in FIG. 4, numbers D111 to D113 are used to denote respective pieces of page information, however, to simplify explanations, hereinafter they are referred to as page information D111) has information such as “page number”, “image size”, “sheet size”, “sheet type”, “pre-punched hole presence in the sheet”, subordinate information of the pre-punched hole presence in the sheet such as “punched hole attribute in the sheet”, “color”, “image direction”, “sheet feeding section specification”, “single-sided or double-sided”, “punching”, and subordinate information of punching such as “punched hole attribute”.

The printing job information D1 has the number of pieces of page information D111 corresponding to the “number of pages” in the job information D11. The “pre-punched hole presence in the sheet” in the page information D111 is information on whether a pre-punched hole is present in the printing sheet to be fed by the sheet feeding section 19, and the “punching” is information on whether to allow the punching section 161 to execute the punching.

The RAM 101 stores “punching function information D2”. The punching function information D2 is information of a punched hole attribute that can be executed by the punching section 161. When the power of the image forming apparatus 1 is turned on and started, the CPU 100 accesses to the punching section 161 to obtain punching function information D2 and to allow the RAM 101 to store the information.

The CPU 100 may access to the punching section 161 to obtaining punching function information D2 and to allow the RAM 101 to store the information when analyzing the punching function information D2. The CPU 100 may update the punching function information D2 stored in the RAM 101 when the punching section 161 becomes inoperable for some reason.

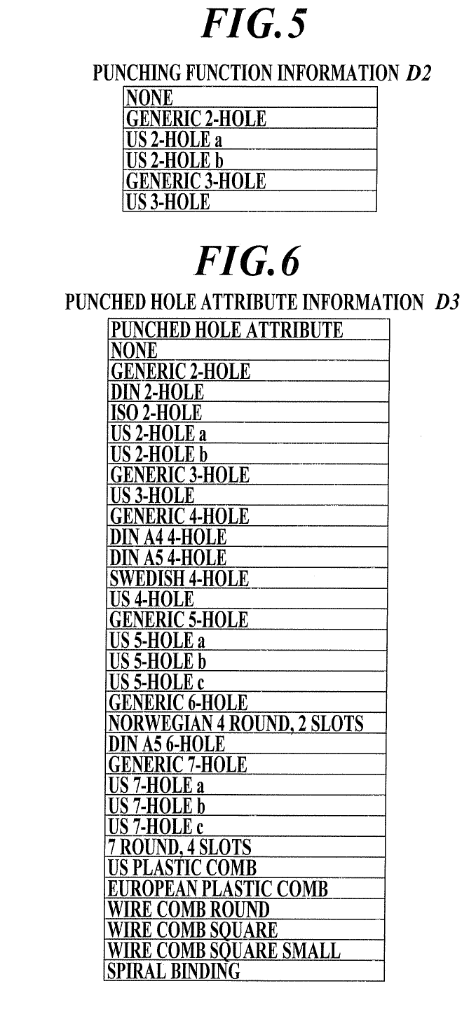

The data configuration of the punching function information D2 is shown in FIG. 5. In FIG. 5, the punching section 161 can execute the punching the punched hole attribute of which is “None” “Generic 2-hole”, “US 2-hole a”, “US 2-hole b”, “Generic 3-hole”, or “US 3-hole”.

The RAM 101 stores “sheet feeding section information D4”. The sheet feeding section information D4 is the attribute information of the printing sheet stored in the sheet feeding section 19, and the RAM 101 stores pieces of the sheet feeding section information D4 respectively corresponding to the sheet feeding sections from the first sheet feeding section 19a to the fourth sheet feeding section 19d. In other words, the RAM 101 stores four pieces of sheet feeding section information D4 in the image forming apparatus 1 shown in FIG. 1.

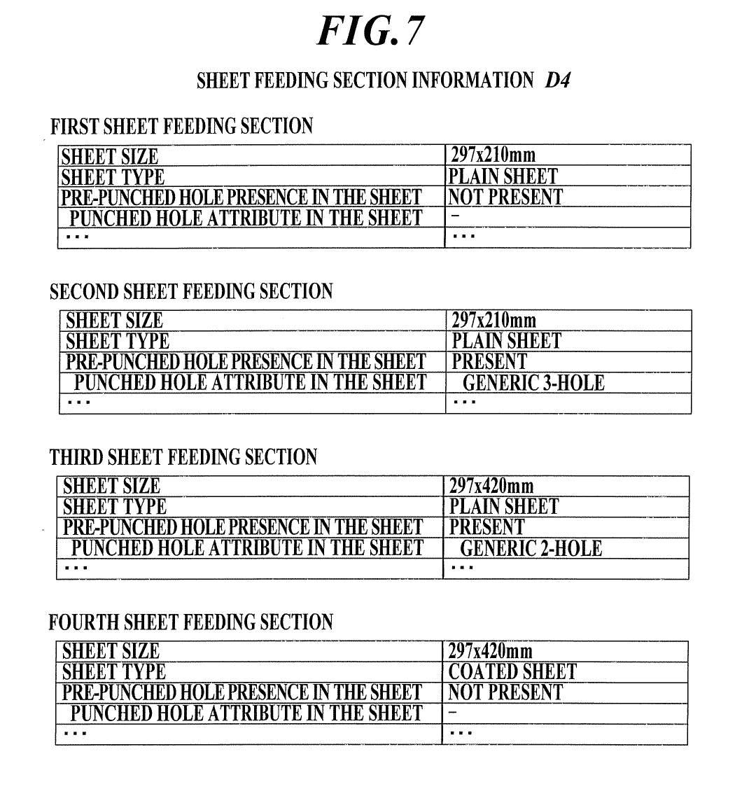

The data configuration of the sheet feeding section information D4 is shown in FIG. 7. The sheet feeding section information D4 includes “sheet size”, “sheet type”, “pre-punched hole presence in the sheet”, “punched hole attribute in the sheet” which is subordinate information of the pre-punched hole presence in the sheet, etc. For example, a plain sheet with the sheet size of “297×210 mm” and with no pre-punched hole is stored in the first sheet feeding section 19a, and a plain sheet with the sheet size of “297×210 mm” and with the pre-punched holes of the attribute of “Generic 3-hole” is stored in the second sheet feeding section 19b.

When the power of the image forming apparatus 1 is turned on and started, the CPU 100 respectively obtains pieces of the sheet feeding section information D4 from sheet feeding sections 19 (the first sheet feeding section 19a to the fourth sheet feeding section 19d) and allows the RAM 101 to store the information. Specifically, when the image forming apparatus 1 is started, the optical sensor 190 provided in each sheet feeding section 19 detects “pre-punched hole presence”, “punched hole attribute”, etc., of the printing sheet stored in each sheet feeding section 19. Then, the CPU 100 obtains the detected information and allows the RAM 101 to store the information as sheet feeding section information D4.

The sheet feeding section 19 may not include an optical sensor 190. In such a case, the user sets the sheet feeding section information D4 through the operating section 18.

The CPU 100 may update the sheet feeding section information D4 stored in the RAM 101 when the printing sheet in the sheet feeding section 19 is replaced by the user.

Specifically, when the printing sheet in the sheet feeding section 19 is replaced, the optical sensor 190 detects the attribute of the printing sheet newly stored in the sheet feeding section 19 and the CPU 100 obtains the detected information to update the sheet feeding section information D4 stored in the RAM 101.

A “punched hole attribute information D3” shown in FIG. 6 is used in the parameters of the “punched hole attribute in the sheet” and the “punched hole attribute” of the page information D111, the “punching function information D2”, and the “punched hole attribute in the sheet” of the sheet feeding section information D4. The punched hole attribute information D3 is information on number, location, size, etc. of the punched hole. The punched hole attribute information D3 is stored in the memory section 102. When the image forming apparatus 1 is turned on and started, the CPU 100 reads the punched hole attribute information D3 from the memory section 102 and allows the RAM 101 to store the information.

The memory section 102 comprises an HDD (Hard Disk Drive), a nonvolatile semiconductor memory, etc. The memory section 102 stores a program for the CPU 100 to control each functional section, information of the processing functions of the image forming apparatus 1, etc., and the CPU 100 reads the information and the program when necessary to execute processing of them in the RAM 101.

The communication I/F section 103 comprises a LAN interface, a modem, etc. and is a functional section which performs data communication with external apparatuses such as a server, a client, other apparatuses and the like through a network, etc. The communication I/F section 103 receives the print job from other communication apparatuses.

The CPU 100 allows the RAM 101 to temporarily store the print job received by the communication I/F section 103. Then, the CPU 100 executes a conversion processing in the RAM 101 to convert the image data included in the print job to printing image data from which the image forming section 17 can form the image on the printing sheet. Various programs for converting the image data to printing image data from which an image can be formed is stored in the memory section 102, and the CPU 100 reads the necessary program.

### (Specific Operation of Image Forming Apparatus)

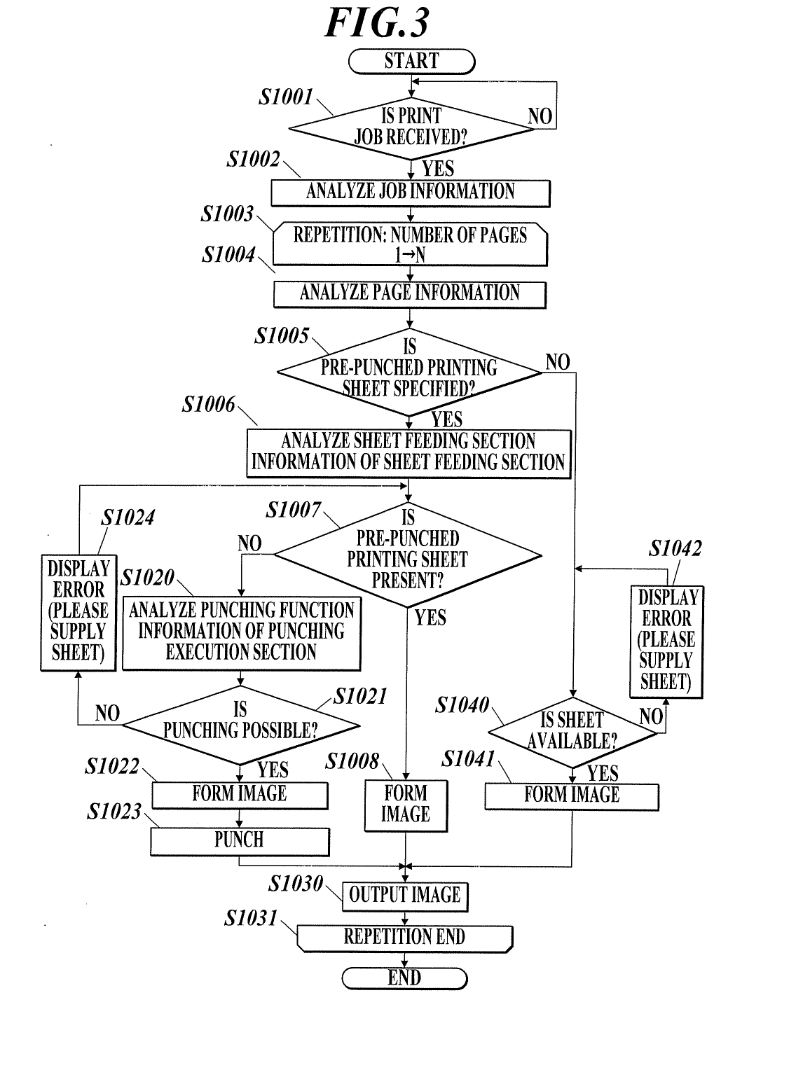

Next, the specific operation of the image forming apparatus 1 is explained, with reference to FIG. 3.

In the case of a print job specifying a printing sheet with the punching process already done, the “punching” is “not execute” and the “pre-punched hole presence in the sheet” is “present” in the page information D111 of the printing job information D1. The case of when the “punching” is “not execute” and the “pre-punched hole presence in the sheet” is “not present”, or when the “punching” is “execute” and the “pre-punched hole presence in the sheet” is “not present” can also be applicable in this embodiment. However, the case of when the “punching” is “execute” and the “pre-punched hole presence in the sheet” is “present” is to be restricted from being set on the screen, etc. when the page information D111 is set.

After an original document sheet is placed in the ADF 14 or on the document stage of the image reading section 15 and the user sets the printing job information D1 on the operating section 18, when a printing start button of the operating section 18 is pushed down, the image forming apparatus 1 starts an image forming processing. Alternatively, in the case of network printing, when the print job is received from the network through the communication I/F section 103, the image forming apparatus 1 starts the image forming processing.

When the control section 10 receives the print job (step S1001: Yes), the control section 10 analyzes the job information D11 of the printing job information D1 included in the print job on the RAM 101 (step S1002). The control section 10 controls the operation of the print job by referring to the “number of pages”, etc. of the job information D11. Specifically, when the “number of pages” is “12”, there are twelve pieces of the page information, thus the operation of step S1003-step S1031 is repeated twelve times.

Next, the control section 10 analyzes the page information D111 (step S1004). As described above, the processing of the analysis of the page information D111 (step S1004) to the processing of the image output (step S1030) is repeated the same number of times as the “number of pages” included in the job information D11 (step S1003, S1031). The analysis of the page information D111 (step S1004) is done each time the operation of the control section 10 returns from step S1031 to step S1003, in the order of the “page number” included in the page information D111. Specifically, the analysis is done in the order of the page information D111, D112, D113 and so on.

If the “pre-punched hole presence in the sheet” of the page information D111 is “present” (pre-punched sheet is specified)(step S1005:Yes), the control section 10 analyzes the “sheet feeding section information D4” of the sheet feeding section 19 stored in the RAM 101 (step S1006).

Then, the control section 10 refers to the sheet feeding section information D4 corresponding to the sheet feeding section 19 which matches the “sheet feeding section specification” included in the page information D111 and determines whether the printing sheet specified in the page information D111 is stored in the sheet feeding section 19 (step S1007).

Specifically, the control section 10 determines whether the “pre-punched hole presence in the sheet” of the sheet feeding section information D4 is “present” and whether the “sheet size”, the “sheet type”, and the “punched hole attribute in the sheet” between the page information D111 and the sheet feeding section information D4 match.

As shown above, the control section 10 analyzes the “sheet feeding section information D4” each time the page information to be analyzed changes from page information D111 to page information D112 to page information D113, comparing the analyzed “sheet feeding section information D4” to the information of the printing sheet included in the page information, to determine the presence or absence of the appropriate pre-punched printing sheet. Thus, even when the appropriate pre-punched printing sheet runs out in the sheet feeding section 19 during the printing processing of a print job, the image forming apparatus 1 executes the later described punching processing, etc. to enable the continuation of the processing of the print job.

In step S1007, the control section 10 refers to the sheet feeding section information D4 corresponding to the sheet feeding section 19 which matches the “sheet feeding section specification” included in the page information D111. Alternatively, the sheet feeding section information D4 corresponding to the other sheet feeding section 19 may be referred. Specifically, the control section 10 may refer to the sheet feeding section information D4 of all of the first sheet feeding section 19a, the second sheet feeding section 19b, the third sheet feeding section 19c, and the fourth sheet feeding section 19d and when the conditions match, may allow the appropriate sheet feeding section 19 to feed the printing sheet. Hereinafter, the same is to be said for when the control section 10 refers to the sheet feeding section information D4.

As a result of the determination, if the conditions match (the appropriate pre-punched printing sheet is available)(step S1007: Yes), the control section 10 allows the sheet feeding section 19 specified by the “sheet feeding section specification” to feed the printing sheet. Then, the control section 10 allows the image forming section 17 to form the image on the printing sheet (step S1008) and allows the image output section 16 to output the printing sheet (step S1030).

In step S1005, if the “pre-punched hole presence in the sheet” of the page information D111 is “not present” (pre-punched sheet is not specified)(Step S1005: No), the control section 10 refers to the sheet feeding section information D4 corresponding to the sheet feeding section 19 which matches the “sheet feeding section specification” included in the page information D111 to determine whether the printing sheet which matches the conditions is available (step S1040).

Specifically, the control section 10 determines whether the information meets the condition of the “punching” of the page information D111 being “not execute”, the “pre-punched hole presence in the sheet” of the sheet feeding section information D4 being “not present” and the “sheet size” and the “sheet type” between the sheet feeding section information D4 and the page information D111 matching respectively (step S1040). Alternatively, the control section 10 determines whether the information meets the condition of the “punching” of the page information D111 being “execute”, the “pre-punched hole presence in the sheet” of the sheet feeding section information D4 being “present”, and the “sheet size”, the “sheet type”, and the “punched hole attribute in the sheet” of the sheet feeding section information D4 matching with the “sheet size”, the “sheet type”, and the “punched hole attribute” of the page information D111 respectively.

When the control section 10 determines that the conditions are fulfilled, (the printing sheet that match the conditions is available) (step S1040: Yes), the control section 10 allows the sheet feeding section 19 specified by the “sheet feeding section specification” of the page information D111 to feed the printing sheet, allows the image forming section 17 to form the image on the printing sheet (step S1041) and allows the image output section 16 to output the printing sheet (step S1030).

If the control section 10 determines that the conditions are not fulfilled (the printing sheet that match the conditions is not available)(step S1040: No), the control section 10 allows the operating section 18 to display a message to set the printing sheet that meet the conditions into the sheet feeding section 19 (step S1042).

Specifically, if the “punching” of the page information D111 is “not execute”, the control section 10 allows the operating section 18 to display a message to set the printing sheet with the “sheet size” and the “sheet type” in the page information D111 without the pre-punched hole into the sheet feeding section 19. Alternatively, if the “punching” of the page information D111 is “execute”, the control section 10 allows the operating section 18 to display a message to set the printing sheet with the “sheet size” and the “sheet type” in the page information D111, and with the pre-punched hole of the “punched hole attribute” in the page information D111 into the sheet feeding section 19. An example of the displayed message is shown in FIG. 8. A detailed description is done below.

In step S1007, if the conditions do not match (appropriate pre-punched printing sheet is not available)(step S1007: No), the control section 10 analyzes the “punching function information D2” of the punching section 161 stored in the RAM 101 (step S1020).

Then, the control section 10 determines whether the punching section 161 can execute the punching process that meet the conditions (the punching process corresponding with the punching process done in the printing sheet specified in the page information D111)(step S1021).

Specifically, the control section 10 compares the “punching function information D2” and the “punched hole attribute in the sheet” included in the page information D111 and determines whether the information meet the conditions of the “punched hole attribute in the sheet” being included in the “punching function information D2”, the “sheet size” and the “sheet type” between the page information D111 and the sheet feeding section information D4 matching respectively, and the “pre-punched hole presence in the sheet” of the sheet feeding section information D4 being “not present”(step S1021).

Since the required pre-punched printing sheet is not stored in the sheet feeding section 19, this determination is done in order to execute the punching process on the printing sheet without the pre-punched hole and to feed and to output the appropriate printing sheet if the punching section 161 can execute the punching process of the appropriate punched hole attribute. If the punching process of the appropriate punched hole attribute cannot be executed, the message to set the appropriate pre-punched printing sheet is displayed. In the end, the user is able to obtain the output of the required pre-punched printing sheet.

In step S1021, if the control section 10 determines that the punching can be executed (step S1021: Yes), the control section 10 allows the sheet feeding section 19 specified in the “sheet feeding section specification” to feed the printing sheet. Then, the control section 10 allows the image forming section 17 to form the image on the printing sheet (step S1022) and allows the punching section 161 to execute the punching of the “punched hole attribute in the sheet” on the printing sheet (step S1023). Then, the control section 10 allows the image output section 16 to output the printing sheet (step S1030).

In step S1021, if the control section 10 determines that the punching cannot be executed (step S1021: No), the control section 10 allows the operating section 18 to display a message to set the printing sheet that meet the conditions into the sheet feeding section 19 (step S1042).

Specifically, the control section 10 allows the operating section 18 to display a message to set the printing sheet of the “sheet size” and the “sheet type” in the page information D111 with the pre-punched hole of the “punched hole attribute in the sheet” in the page information D111 into the sheet feeding section 19. An example of the displayed message is shown in FIG. 8.

In step S1030, when the control section 10 allows the image output section 16 to output the image (output the printing sheet), the analysis of the next page information D112 is executed (step S1004). If the next page information does not exist, the print job is terminated.

As for the determination of whether the specified printing sheet is stored in the sheet feeding section 19 in step S1007, it may be determined unconditionally that the specified printing sheet is not stored (step S1007: No).

### (Example of Screen)

Next the screen is described with reference to FIG. 8. FIG. 8 is a display screen to inform the user of supplying the appropriate printing sheet (hereinafter referred to as the printing sheet supply screen 180). The printing sheet supply screen 180 has a “sheet supply completed” button 180a and a “cancel printing” button 180b. The user pushes down the “sheet supply completed” button 180a, after supplying the printing sheet specified on the screen into the specified sheet feeding section 19. Alternatively, the user can cancel the printing by pushing down the “cancel printing” button 180b.

According to the embodiments of the present invention, in a print job where a pre-punched printing sheet is specified, when the specified pre-punched printing sheet is not stored in the sheet feeding section 19, the image forming apparatus 1 performs the punching processing to form the punched hole corresponding to the punched hole in the specified pre-punched printing sheet.

Therefore, even when the specified pre-punched printing sheet is not stored in the sheet feeding section 19, the user may obtain the printing result specified by the print job. Thus, the user does not have to do processes such as setting a pre-punched printing sheet, setting the image forming apparatus again to form the image, etc. Consequently, the burden of the user operation decreases.

What is claimed is:

1. An image forming apparatus to perform an image forming processing based on a print job comprising:
a sheet feeding section to feed a stored printing sheet;
a punching section to perform a punching processing in a printing sheet; and
a control section to allow the punching section to perform the punching processing to form a punched hole corresponding to a punched hole in a pre-punched printing sheet specified by the print job when an image processing based on the print job is executed.

2. The image forming apparatus of claim 1, wherein
the control section determines whether the pre-punched printing sheet specified by the print job is stored in the sheet feeding section, and when the pre-punched printing sheet is determined to be stored, the control section allows the sheet feeding section to feed the pre-punched printing sheet, and when the pre-punched printing sheet is determined to be not stored, the control section allows the punching section to perform the punching processing to form the punched hole corresponding to the punched hole in the printing sheet specified by the print job.

3. The image forming apparatus of claim 2, wherein
the control section refers to presence or absence of the pre-punched hole and an attribute of the pre-punched hole in the printing sheet stored in the sheet feeding section, and determines whether the pre-punched printing sheet specified by the print job is stored in the sheet feeding section.

4. The image forming apparatus of claim 2, wherein
the control section refers to an attribute of a punched hole which the punching section can form and presence or absence of the punched hole in the printing sheet stored in the sheet feeding section to allow the punching section to perform the punching processing to form the punched hole corresponding to the punched hole in the printing sheet specified by the print job.

5. The image forming apparatus of claim 2, further comprising an operating section to receive a setting input of presence or absence of the pre-punched hole and an attribute of the pre-punched hole in the printing sheet stored in the sheet feeding section, wherein
the control section refers to information set based on the setting input received by the operating section.

6. The image forming apparatus of claim 2, wherein
the sheet feeding section comprises an optical sensor to detect presence or absence of the pre-punched hole and an attribute of the pre-punched hole in the printing sheet stored in the sheet feeding section, and the control section refers to information detected by the optical sensor.

7. The image forming apparatus of claim 2, wherein
the control section performs the determination with respect to each page of the printing sheet.

8. A computer-readable medium storing a program for a computer, provided in an image forming apparatus which includes a sheet feeding section to feed a stored printing sheet and a punching section to perform a punching processing in a printing sheet and which performs image forming processing based on a print job, the program allowing the computer to function as a control section to allow the punching section to perform the punching processing to form a punched hole corresponding to a punched hole in a pre-punched printing sheet specified by the print job when the image processing is executed based on the print job.
